(19) United States
(12) Patent Application Publication
(10) Pub. No.: US 2009/0210405 A1
(43) Pub. Date: Aug. 20, 2009

(54) Method, system, and apparatus for providing advice to users

(76) Inventors: Kerry A. Ortega, Raleigh, NC (US); Mark E. Molander, Cary, NC (US); Thomas Brugler, Fuquay-Varina, NC (US); Todd Michael Eischeid, Cary, NC (US)

Correspondence Address: MAXVALUEIP CONSULTING LLC, 11204 ALBERMYRTLE ROAD, POTOMAC, MD, 20854, US

(21) Appl. No.: 12/031,753

(22) Filed: Feb. 15, 2008

(51) Int. Cl. G06F 17/30

(52) U.S. Cl. 707/5; 707/E17.059

(57) ABSTRACT

In one embodiment of this invention, one can record and provide answers to users problems. When a user selects a command (e.g., Show Tips) on the user interface (UI), the mouse pointer is changed, so when the user clicks on an aspect of the UI, a web window displays all of the problems that the users have entered on the particular clicked item by querying a forum knowledge base. One embodiment provides capability to expand the search, e.g., to anything the user clicked on recently or items which are related to the selected item.

### BACKGROUND OF THE INVENTION

Many web sites and applications let users enter their problems and questions to a forum and let users search the forums for the answers as well as provide answers to other users' questions. Automated advice systems provide an automated system to help and guide system users in finding and selecting products, services, or other selectable elements, that best meet their needs and preferences as expressed in a set of target preferences. These systems obtain information from and about users to assess their needs and preferences and provide a list of items and information about those items based upon information provided by a user. The system prompts a user with regard to a type of item in which the user is interested. Based upon the answers provided by the user, the system scores the available items in terms of how well they match the user's needs and preferences and generates ranked lists of items.

During the software development and testing of graphical user interface (GUI) applications, it will be beneficial to have a capability to ascertain users' problems and provide tips and solutions based on a forum knowledge base in a seamless way through user interface (UI).

### SUMMARY OF THE INVENTION

In an embodiment of the invention, as customers enter problems to the forum, forum readers can provide answers to these questions or workarounds, etc. In the UI, a user can click on a command (e.g., Show Tips) that will change the mouse pointer to another pointer, and then, the user clicks on an aspect of the UI. The UI then opens up a web window and show all of the problems that users have entered on the particular item that was clicked. The user can expand the search (e.g., to anything they've clicked on in the last 5 minutes) or things that are related to the items they clicked on. The exchange of the information about a particular search can also be sent either via a web based method such as posting the message into a web page or an e-mail can be sent to the requester.

### BRIEF DESCRIPTION OF THE DRAWINGS

FIG. 1 is a schematic diagram of the system with different options provided to the user.

FIG. 2 is the general data flow through an embodiment of the system.

### DETAILED DESCRIPTION OF THE PREFERRED EMBODIMENTS

An increasing number of specialized searchable databases are available online. Often significant effort has been put into creating such databases, which might contain listings of common problems that have been experienced by developers or people searching for the same information.

The information extracted from search results can be presented and integrated with other search results within a forum and presented in a separate window. Moreover this latest information can be added to the knowledgebase in order to grow the forum.

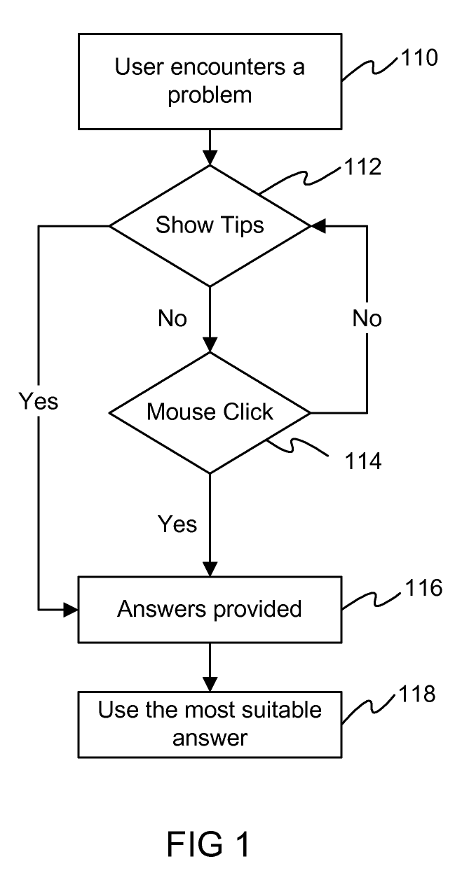

An embodiment of the invention (FIG. 1) provides tool tip (112) so the user (for example, who might have encountered a problem (110) or has a question about an aspect of UI) can slide the mouse on top of an aspect of UI to display the questions and answers associated with that item (214). In one embodiment, the user can click (114 or 210) on the item and drill down into more detailed forums with multiple questions and answers (116). The embodiment provides the search capability to the user to query the forum (218), e.g. based on rankings of the answers (118), the items clicked recently by the user, and other related items.

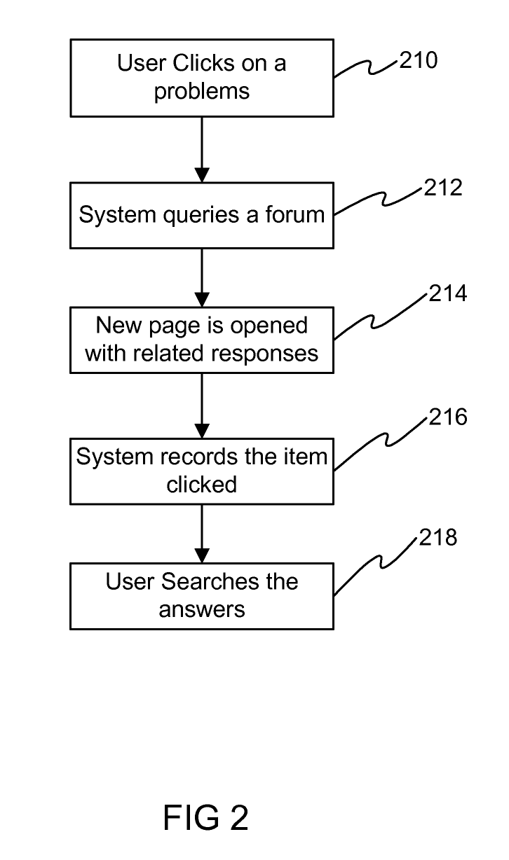

FIG. 2 is the depiction of an embodiment of the invention. It queries the various forums to find the best possible choices to be presented to the user (212). The system also records the items that the user is searching about in order to use it in its prioritization and presentation to subsequent users (216).

Graphical User Interfaces (GUI) is designed to interact with users. An embodiment of the invention will allow the tagging and reporting of problems within the GUI. Moreover, it will allow the users to extract the previous results of other searches conducted by other users with similar problems. Within a GUI application it allows users to report problems through UI (e.g., by automatically tagging problems). One embodiment of the invention is a method comprising:
User selects “Show Tips” command or use a Mouse click and/or key combination shortcut (e.g. Alt+click) (e.g. after encountering a problem within the system's interface).
User clicks on an UI element.
The system queries a forum for problems dealing with the UI element clicked.
The system opens up a web window and shows the list of problems associated with the UI element clicked and any related responses to those problems from the forum.
The system records UI element clicked and the user information can be used in the forum to sort problems based on the user request (the development team also gets a report on which items were queried).
User can then search the list for answers.

Another embodiment of the invention is a method of providing tips to a user in a graphical user interface application, the method comprising:
providing a function to give hint or solution for a problem;
the user invoking the function, by clicking, pointing, or selecting, using a mouse, keyboard, menu, pointing device, or shortcut;
the user specifying the problem;
searching for a forum dealing with the problem;
querying the forum about the problem;
the forum providing live and delayed hint or solution for the problem, by searching prior chat or advice recordings, by providing similar topics, by providing comment trails between the forum's participants, by invoking an agent or robot, and by engaging live chats with experts in the forum;
providing a report for the user; wherein the report comprising ranking, relevance rating, and expertise rating;
searching for other users interested in the problem, using prior discussions;
grouping the other users into a first group;
determining e-mail preference of all members of the first group;
ranking the all members of the first group based on their expertise level, related to the problem, and their availability during a specified period of time;
based on the ranking of the all members of the first group, selecting a first member of the first group;
if the e-mail preference of the first member of the first group is receiving e-mail, then sending an e-mail along with the report to the first member of the first group; and
if the e-mail preference of the first member of the first group is receiving instant-message, then sending an instant-message invitation along with the report, to both the first member of the first group and to the user, to participate in an instant message session.

A system, apparatus, or device comprising one of the following items is an example of the invention: tip or hint, tool tip, GUI, mouse, keyboard, menu, pointing device, shortcut, forum, query result, email server or client, instant message server or client, on-line chat, robot, problem expert, report, ranking, rating, time, session, or any software, applying the method mentioned above, for purpose of invitation or providing tips to a user in a graphical user interface application.

Any variations of the above teaching are also intended to be covered by this patent application.

1. A method of providing tips to a user in a graphical user interface application, said method comprising:
providing a function to give hint or solution for a problem;
said user invoking said function, by clicking, pointing, or selecting, using a mouse, keyboard, menu, pointing device, or shortcut;
said user specifying said problem;
searching for a forum dealing with said problem;
querying said forum about said problem;
said forum providing live and delayed hint or solution for said problem, by searching prior chat or advice recordings, by providing similar topics, by providing comment trails between said forum's participants, by invoking an agent or robot, and by engaging live chats with experts in said forum;
providing a report for said user;
wherein said report comprising ranking, relevance rating, and expertise rating;
searching for other users interested in said problem, using prior discussions;
grouping said other users into a first group;
determining e-mail preference of all members of said first group;
ranking said all members of said first group based on their expertise level, related to said problem, and their availability during a specified period of time;
based on said ranking of said all members of said first group, selecting a first member of said first group;
if said e-mail preference of said first member of said first group is receiving e-mail, then sending an e-mail along with said report to said first member of said first group; and
if said e-mail preference of said first member of said first group is receiving instant-message, then sending an instant-message invitation along with said report, to both said first member of said first group and to said user, to participate in an instant message session.
